(19) United States
(12) Patent Application Publication
(10) Pub. No.: US 2019/0300278 A1
(43) Pub. Date: Oct. 3, 2019

(54) PARTITIONED PLASTIC LINER BAG AND WASTE RECEPTACLE FOR BLOCKING ODOR

(71) Applicant: Bassam Abed, Bakersfield, CA (US)

(72) Inventor: Bassam Abed, Bakersfield, CA (US)

(21) Appl. No.: 16/369,045

(22) Filed: Mar. 29, 2019

Related U.S. Application Data
(60) Provisional application No. 62/702,187, filed on Jul. 23, 2018.
(60) Provisional application No. 62/650,721, filed on Mar. 30, 2018.

(51) Int. Cl. B65F 1/00; B65D 33/28

(52) U.S. Cl. CPC B65F 1/002; B65D 33/28

(57) ABSTRACT

Waste receptacles and plastic bags which are used as liners for waste receptacles, and more particularly to a partitioned or split bag having at least one intermediate sealing apparatus such as a drawstring, strap with handles, draw tape, tie wrap, twist tie, hook and loop fastener or other closure fixture to seal a portion of the bag and block and reduce odor within the bottom of the bag while the bag remains within the waste receptacle.

### RELATED APPLICATIONS

This application claims the benefit of priority to U.S. Provisional Application, 62/702,187, filed Jul. 23, 2018 and to U.S. Provisional Application, application No. 62/650,721 filed Mar. 30, 2018, the entire contents of each of which are expressly incorporated herein by reference.

### FIELD OF THE INVENTION

The present invention relates to waste receptacles and to plastic liner bags which are used as liners for waste receptacles, and more particularly to a partitioned or split bag having at least one intermediate closure fixture such as a drawstring, draw tape, tie wrap, twist tie, hook and loop fastener or other sealing fixture to seal a portion of the bag and block and reduce odor within the bottom of the bag while the bag remains within the waste receptacle.

### BACKGROUND OF THE INVENTION

In order to maintain sanitary conditions, plastic bags have been used to line waste receptacles to prevent waste or other materials from contacting the receptacle. Commonly the waste receptacle when partially filled emits strong and unpleasant odors from the contents of rubbish. Extensions on the top of the bag provide for closure of the bag when full using twist ties, drawstring handles, or other closure fixtures to seal the rubbish within the bag and block or reduce odors when emptying the container. However, what is not known is a method and apparatus to block or reduce odors when the bag is partially full.

### SUMMARY OF THE INVENTION

Embodiments of the present invention relate to a partitioned plastic liner bag having a closure fixture at the top of bag such as is known in the prior art and one or more additional closure fixtures that surround and close a portion of the bag to seal off the waste contents and odor produced by the waste within a partially filled bag.

Embodiments of the present invention further relate to a waste receptacle having one or more access points to grab and pull the closure fixture to seal a portion of the plastic liner bag without removing the bag from the waste receptacle.

It is an object and advantage of the present invention to provide a partitioned plastic liner bag useable within a waste receptacle having a closure fixture at the top of the liner bag to seal the contents of the bag when full and an intermediate closure fixture along a portion of the partitioned liner bag to seal the contents of the bag when partially full.

It is an object and advantage of the present invention that the upper and intermediate closure fixtures be accessible to pull at one or more intermediate points to draw the plastic liner bag closed to seal the contents.

It is an object and advantage of the present invention that the upper and intermediate closure fixtures be accessible from the outside of the plastic liner bag at one or more intermediate points so that the intermediate closure fixture may be pulled outwards to draw the plastic liner bag closed to seal the contents within a portion of the bag.

It is an object and advantage of the present invention that the intermediate closure fixture be accessible from the inside of the plastic liner bag at one or more intermediate points so that the intermediate closure fixture may be pulled inwards to draw the plastic liner bag closed to seal the contents within a portion of the bag.

It is an object and advantage of the present invention that the upper and intermediate closure fixtures be drawstrings, draw tape, tie wraps, twist ties, hook and loop fasteners or other sealing apparatus.

It is an object and advantage of the present invention that the plastic material of the liner bag be flexible and elastic to expand without rupture when being sealed using the upper and/or intermediate closure fixtures.

It is an object and advantage of the present invention that embodiments of the partitioned liner bag be disposable.

It is an object and advantage of the present invention that the waste receptacle of the present invention provide access to the intermediate closure fixture to seal the contents of a partially filled liner bag without removing the bag from the waste receptacle.

The present invention is related to a plastic liner bag comprising a layered flexible sheet material sealed along a bottom portion and side edges to form a bag; at least one intermediate closure fixture positioned along an intermediate portion of the bag; and wherein the at least one intermediate closure fixture is configured to seal a portion of the bag. In embodiments of the plastic liner bag, the intermediate closure fixture is accessible from the outside of the plastic liner bag. In embodiments of the plastic liner bag, the intermediate closure fixture is accessible from the inside of the plastic liner bag. In embodiments of the plastic liner bag, the intermediate closure fixture is a drawstring and wherein the drawstring is configured to seal a portion of the bag by pulling and tying off the drawstring. In embodiments of the plastic liner bag, the intermediate closure fixture is a strap having a first handle and a second handle, the strap configured to seal a portion of the bag by pulling and tying the first and second handles together. In embodiments of the plastic liner bag, the intermediate closure fixture is a band that has a first loop and a second loop, the band configured to seal a portion of the bag by pulling the first loop through the second loop. In embodiments of the plastic liner bag, the intermediate closure fixture is a draw tape having an adhesive tab, the draw tape configured to seal a portion of the bag by pulling and securing the adhesive tab to the bag or to the draw tape. In embodiments of the plastic liner bag, the intermediate closure fixture is a hook and loop fastener configured to be aligned to seal a portion of the bag. In embodiments of the plastic liner bag, the intermediate closure fixture is a tie wrap configured to seal a portion of the bag. Embodiments of the partitioned plastic liner bag comprises a closure fixture positioned along an upper edge of the bag.

Embodiments of the plastic liner bag may comprise a waste receptacle having cutouts to access the intermediate closure fixture to seal a portion of the bag without removing the bag from the waste receptacle. Embodiments of the plastic liner bag may comprise a waste receptacle having a semi-circular opening that extends through a portion of the sidewall of the waste receptacle to access the intermediate closure fixture to seal a portion of the bag without removing the bag from the waste receptacle.

The present invention is further related to a method of sealing a plastic liner bag to block odor in a waste receptacle, comprising layering a first flexible sheet material over a second flexible sheet material and sealing along a bottom portion and side edges to form a bag; positioning at least one closure fixture in an intermediate portion along the bag; and sealing a portion of the bag using the at least one closure fixture positioned along the intermediate portion. Embodiments of the method of sealing a plastic liner bag to block odor in a waste receptacle may comprise positioning the at least one closure fixture along an intermediate portion on the outside of the plastic liner bag. Embodiments of the method of sealing a plastic liner bag to block odor in a waste receptacle may comprise positioning the at least one closure fixture along an intermediate portion on the inside of the plastic liner bag. Embodiments of the method of sealing a plastic liner bag to block odor in a waste receptacle may comprise forming the intermediate closure fixture as a drawstring configured to be pulled and tied to seal a portion of the plastic liner bag. Embodiments of the method of sealing a plastic liner bag to block odor in a waste receptacle may comprise forming the intermediate closure fixture as a strap with two handles, the strap configured to seal a portion of the plastic liner bag by tying the two handles together. Embodiments of the method of sealing a plastic liner bag to block odor in a waste receptacle may comprise forming the intermediate closure fixture as a draw tape having an adhesive tab, the draw tape configured to seal a portion of the plastic liner bag by pulling and securing the adhesive tab to the bag or to the draw tape. Embodiments of the method of sealing a plastic liner bag to block odor in a waste receptacle may comprise forming the intermediate closure fixture as a hook and loop fastener, the hook and loop fastener configured to be aligned to seal a portion of the plastic liner bag. Embodiments of the method of sealing a plastic liner bag to block odor in a waste receptacle may comprise forming the intermediate closure fixture as a tie wrap configured to seal a portion of the bag. Embodiments of the method of sealing a plastic liner bag to block odor in a waste receptacle may comprise forming a waste receptacle with at least one portion along its outer wall removed to form a cut out to provide access to the intermediate closure fixture without removing the bag from the waste receptacle.

The objects and features of the present invention, which are believed to be novel, are set forth with particularity in the appended claims. These aspects of the invention are not meant to be exclusive and other features, aspects, and advantages of the present invention will be readily apparent to those of ordinary skill in the art when read in conjunction with the appended claims and accompanying drawings.

### BRIEF DESCRIPTION OF THE DRAWINGS

Specific embodiments of the invention have been chosen for the purpose of illustration and description, and are shown in the accompanying drawings, which form a part of this specification. The present invention, both as to its organization and manner of operation, together with further objects and advantages, may best be understood by reference to the following description, taken in connection with the accompanying drawings, wherein:

FIG. 1 is a perspective view of an embodiment of a partitioned plastic liner bag having an intermediate closure fixture;

FIG. 2 is an elevation view of an embodiment of a partitioned plastic liner bag having an intermediate closure fixture;

FIG. 3 is a perspective view of an embodiment of a waste receptacle of the present invention having cutouts to access the intermediate closure fixture of the partitioned plastic liner bag positioned within the waste receptacle;

FIG. 4 is a perspective view of the embodiment of a waste receptacle having cutouts of FIG. 3 and an embodiment of the partitioned plastic liner bag with the intermediate closure fixture sealed within the waste receptacle;

FIG. 5 is a perspective view of another embodiment of a partitioned plastic liner bag having an intermediate closure fixture with the intermediate closure fixture positioned on the outside of the plastic liner bag;

FIG. 6 is an elevation view of the embodiment of a partitioned plastic liner bag having an intermediate closure fixture of FIG. 5;

FIG. 7 is a perspective view of an embodiment of a waste receptacle having cutouts and the embodiment of the partitioned plastic liner bag having an intermediate closure fixture of FIG. 5 positioned within the waste receptacle;

FIG. 8 is a perspective view of an embodiment of a waste receptacle having cutouts with the embodiment of the partitioned plastic liner bag having an intermediate closure fixture of FIG. 5 positioned within the waste receptacle and handles of the partitioned liner bag extending through the cutouts of the waste receptacle;

FIG. 9 is a perspective view of a further embodiment of a waste receptacle having a semi-circular section removed and an embodiment of the partitioned plastic liner bag having an intermediate closure fixture positioned within the further embodiment of the waste receptacle;

FIG. 10 is a perspective view of the embodiment of a waste receptacle of FIG. 9 and an embodiment of the partitioned plastic liner bag with the intermediate closure fixture sealed within the waste receptacle;

FIG. 11 is a perspective view of an embodiment of the partitioned plastic liner bag with the intermediate closure fixture positioned on the outside of the plastic liner bag sealing the lower portion of the partitioned plastic liner bag;

FIG. 12 is a perspective view of an embodiment of the partitioned plastic liner bag having the intermediate closure fixture positioned on the outside of the plastic liner bag sealing the lower portion and the upper closure fixture sealing the upper portion of the partitioned plastic liner bag;

FIG. 13 is a perspective view of another embodiment of the partitioned plastic liner bag having an intermediate closure fixture formed using adhesive tabs;

FIG. 14 is a perspective view of a further embodiment of the partitioned plastic liner bag having an intermediate closure fixture formed with a hook and loop fastener;

FIG. 15 is a perspective view of a still further embodiment of the partitioned plastic liner bag having an intermediate closure fixture formed using a cable tie;

FIG. 16 is a perspective view of a further embodiment of a partitioned plastic liner bag having an intermediate closure fixture positioned on the inside of the plastic liner bag;

FIG. 17 is an elevation view of the embodiment of the partitioned plastic liner bag having the intermediate closure fixture on the inside of the plastic liner bag of FIG. 16 within a waste receptacle;

FIG. 18 is a top view of an embodiment of a partitioned plastic liner bag having an intermediate closure fixture on the inside of the plastic liner bag of FIG. 16 within a waste receptacle; and

FIG. 19 is a perspective view of the embodiment of the partitioned plastic liner bag having the intermediate closure fixture on the inside of the plastic liner bag of FIG. 16 sealing the lower portion of the partitioned plastic liner bag.

### DETAILED DESCRIPTION OF THE DRAWINGS

The present disclosure illustrates one or more preferred embodiments of the present invention. It is not intended to provide an illustration or encompass all embodiments contemplated by the present invention. In view of the disclosure of the present invention contained herein, a person having ordinary skill in the art will recognize that innumerable modifications and insubstantial changes may be incorporated or otherwise included into the depicted embodiments without diverging from the spirit of the invention. Therefore, it is understood that the present invention is not limited to the embodiments disclosed herein. Rather, the scope of the invention shall be broadly defined by the appended claims which are intended to more fully and accurately encompass the invention to the fullest extent possible. However, it is fully appreciated that the use of certain terminology shall not be construed to conclusively limit the scope of protection if otherwise within the spirit of the present invention.

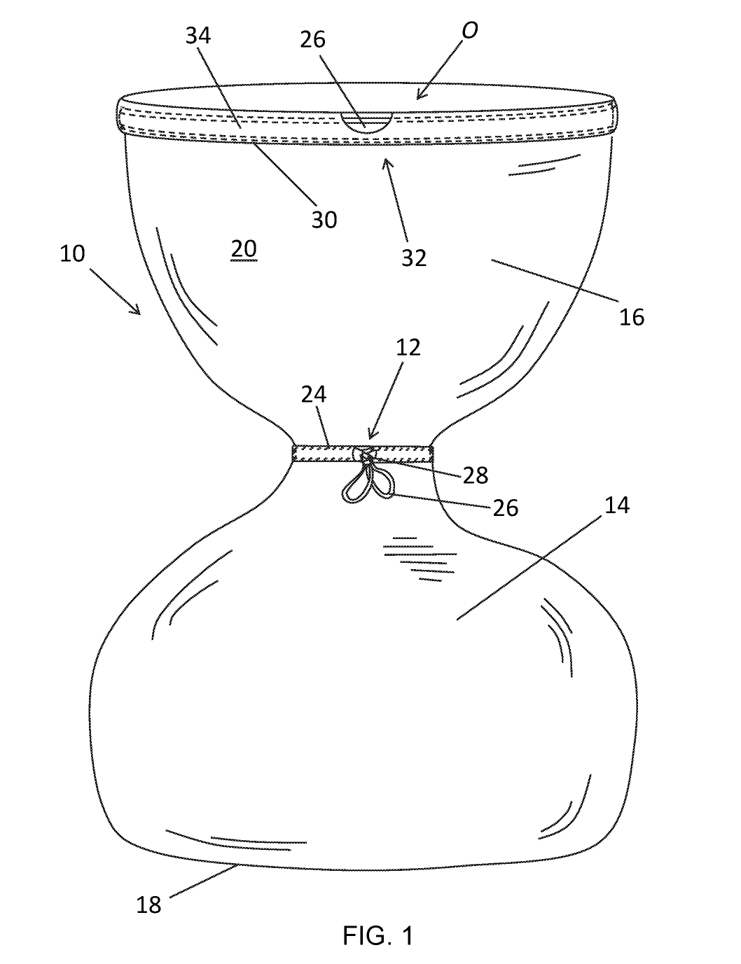

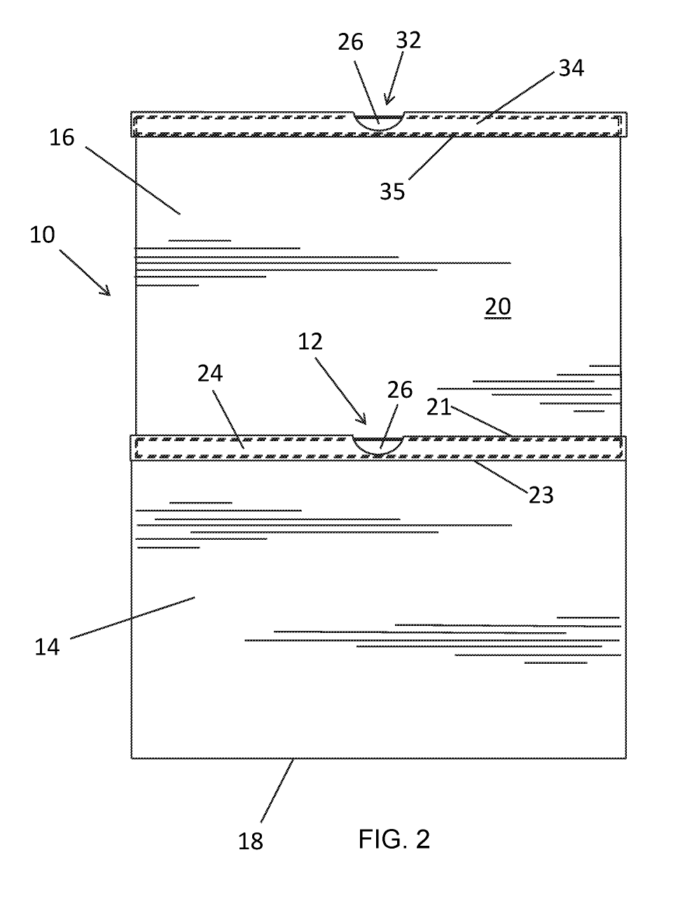

In FIG. 1, a perspective view of the partitioned or split plastic liner bag 10 of the present invention is shown. The partitioned liner bag 10 is formed with an intermediate closure fixture 12 that divides the bag 10 into a lower portion 14 and an upper portion 16. In some embodiments, the partitioned liner bag 10 may be formed from a tubular sheet of polymeric material that is cut to a desired length and sealed along a bottom 18. In the embodiment of FIG. 1, the intermediate closure fixture 12 is placed along the outer surface 20 at an intermediate portion of the bag 10 and some of the tubular sheet material is overlapped or additional sheet material is provided to cover the intermediate closure fixture 12. The overlapped portion or sheet material is then adhered to the outer surface 20 of the plastic liner bag 10 along an upper edge 21 and a lower edge 23 to form a sleeve 24, as shown in FIG. 2. The intermediate closure fixture 12 is inserted within the sleeve 24 around the partitioned liner bag 10 and moves freely within the sleeve 24. In some embodiments of the partitioned liner bag 10, the intermediate closure fixture 12 is two drawstrings 26 that provide for sealing the lower portion 14 by pulling each drawstring 26 in opposing directions and tying them in a knot 28. In some embodiments, to provide sealing the top of the partitioned liner bag 10, the upper edge 30 is folded over an upper closure fixture 32 forming a hem 34 and an upper edge 33 and a lower edge 35 of the hem 34 is adhered to the outer surface 20 of the plastic liner bag 10 to provide for the upper closure fixture 32 to slide freely through the hem 34. The upper closure fixture 32 may similarly be two drawstrings 26 that seal the upper portion 16 by pulling each drawstring 26 in opposing directions and tying the two upper drawstrings 26 together. As shown in FIG. 1, the lower portion 14 of the portioned liner bag 10 may be closed while the upper portion 16 provides an opening O for additional trash to be placed in the liner bag 10. The described construction of the partitioned liner bag 10 is one of various methods that may be used, and the particular method of manufacture is not intended to limit the present invention in any way.

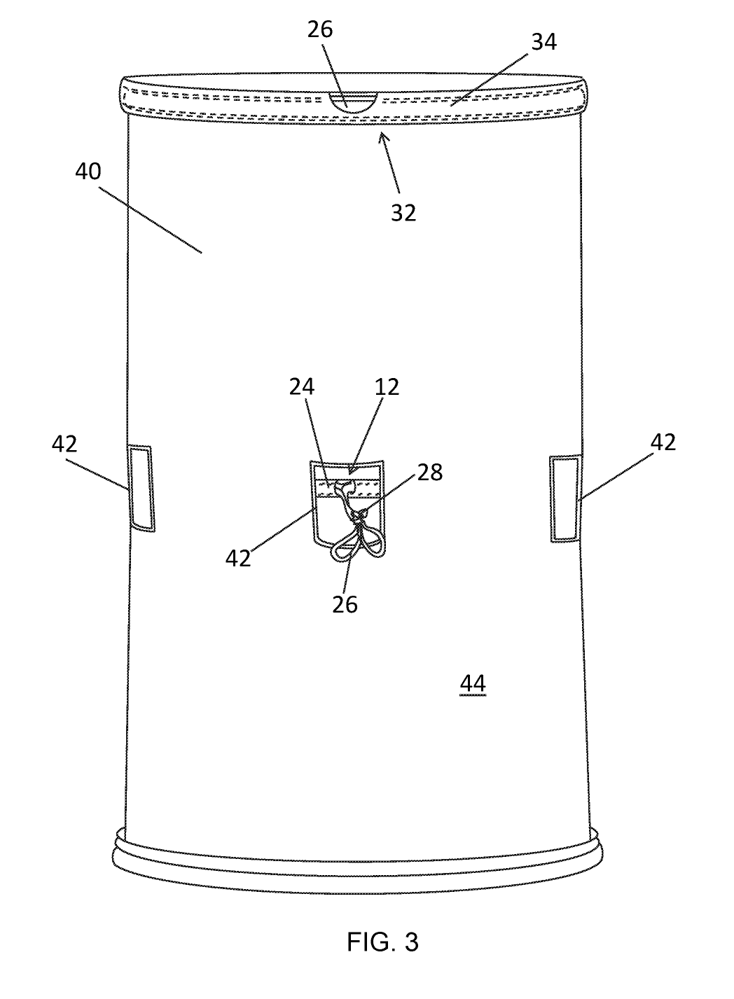

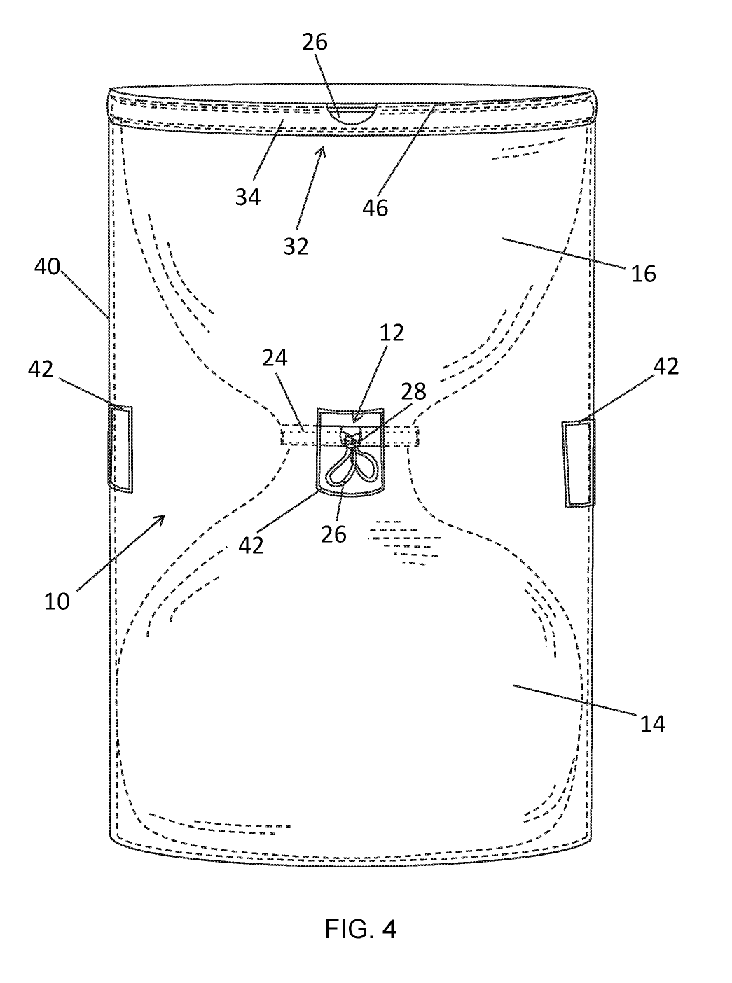

In some embodiments, as shown in the side elevation view in FIG. 2, the upper portion 16 and lower portion 14 may be of equal dimensions, although dimensions of any desirable length, width and volume is within the scope of the present invention. The dimensions may be suitable to be used in waste receptacles of various sizes. The intermediate closure fixture 12 as well may be placed anywhere along the partitioned liner bag 10 to separate the bag into desired proportions. The present invention further provides waste receptacles 40, that may be of any suitable shape, size and dimensions. In a first embodiment of the waste receptacle 40 of the present invention a plurality of cutouts 42 that extend through the sidewall 44 of the waste receptacle 40 are provided, an embodiment of which is shown in FIG. 3. The cutouts 42 are large enough openings to reach through the cutout 42 and grab the intermediate closure fixture 12 to seal the lower portion 14 of the partitioned liner bag 10. For example, if the intermediate closure fixture 12 is two drawstrings 26, as shown in the embodiment in FIG. 3, then each of the two drawstrings 26 are pulled through a cutout 42 on one side of the waste receptacle 40. The two drawstrings 26 are then tied in a knot 28 to seal the lower portion of the partitioned liner bag 10. If desired, each of the two drawstrings 26 may also be pulled through another cutout 42 that is on the opposing side of the waste receptacle 40 and also be tied in a knot 28 to securely close the lower portion 14 of the partitioned liner bag 10. As shown in FIG. 4, the lower portion 14 of the partitioned liner bag 10 may therefore be sealed while remaining in the waste receptacle 40 to reduce odors from rubbish in the bottom of the bag 10 with the hem 34 and the upper closure fixture 32 remaining pulled over the upper edge 46 of the waste receptacle 44 holding the upper portion 16 of the partitioned liner bag 10 in an opened positioned.

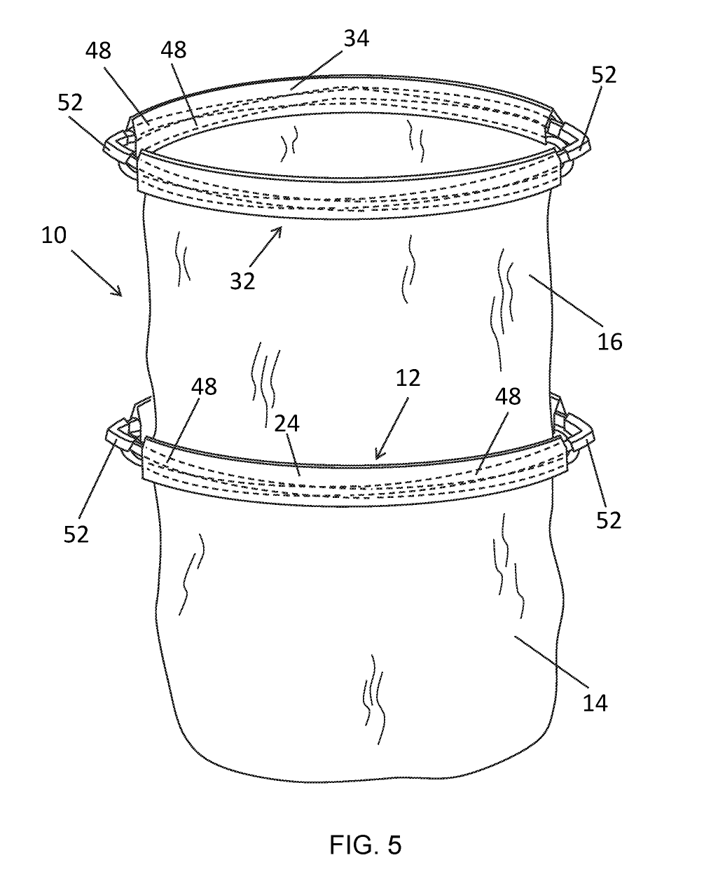

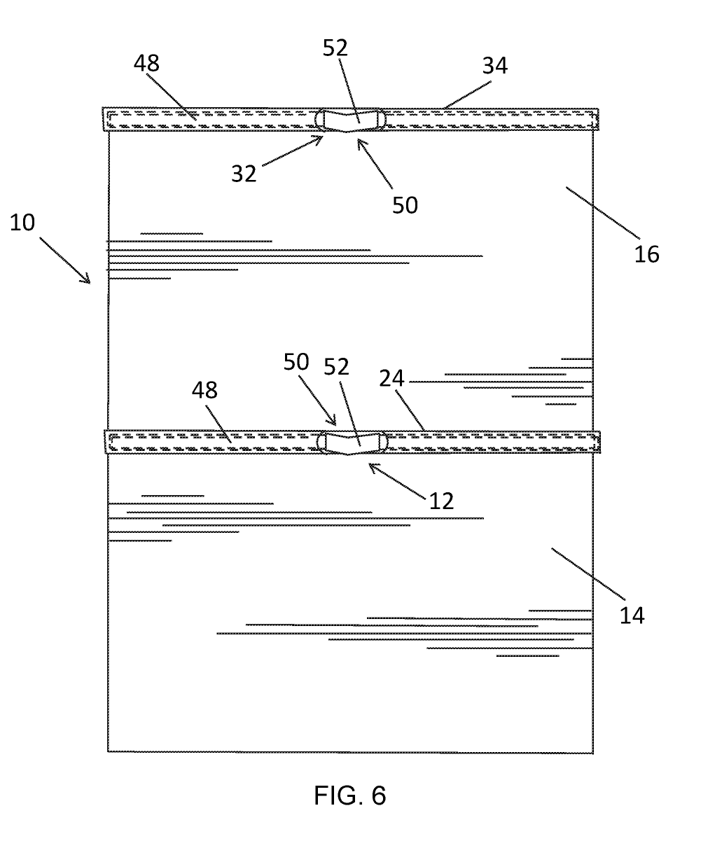

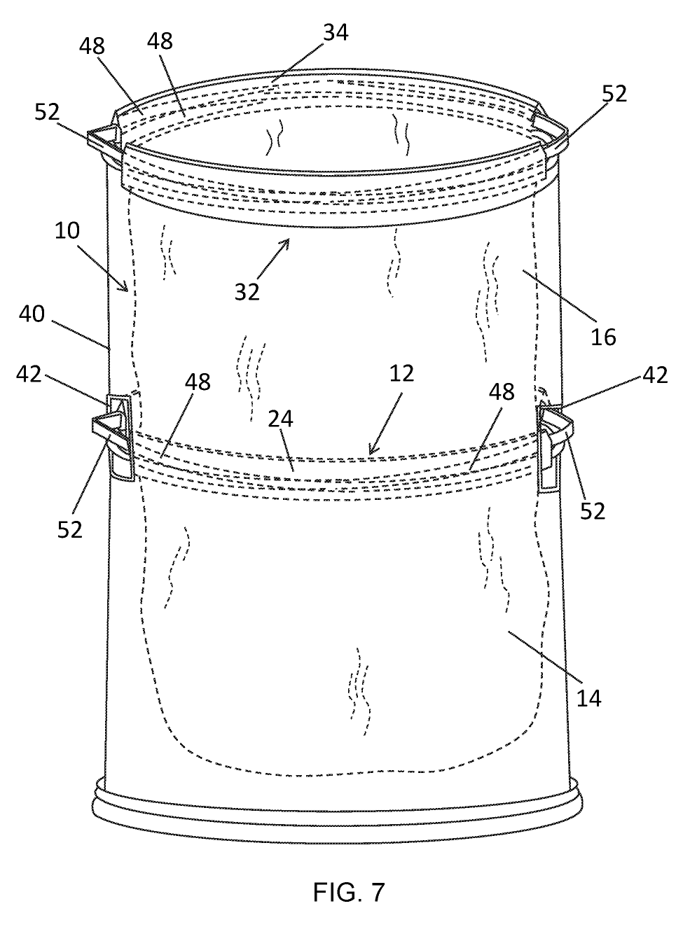

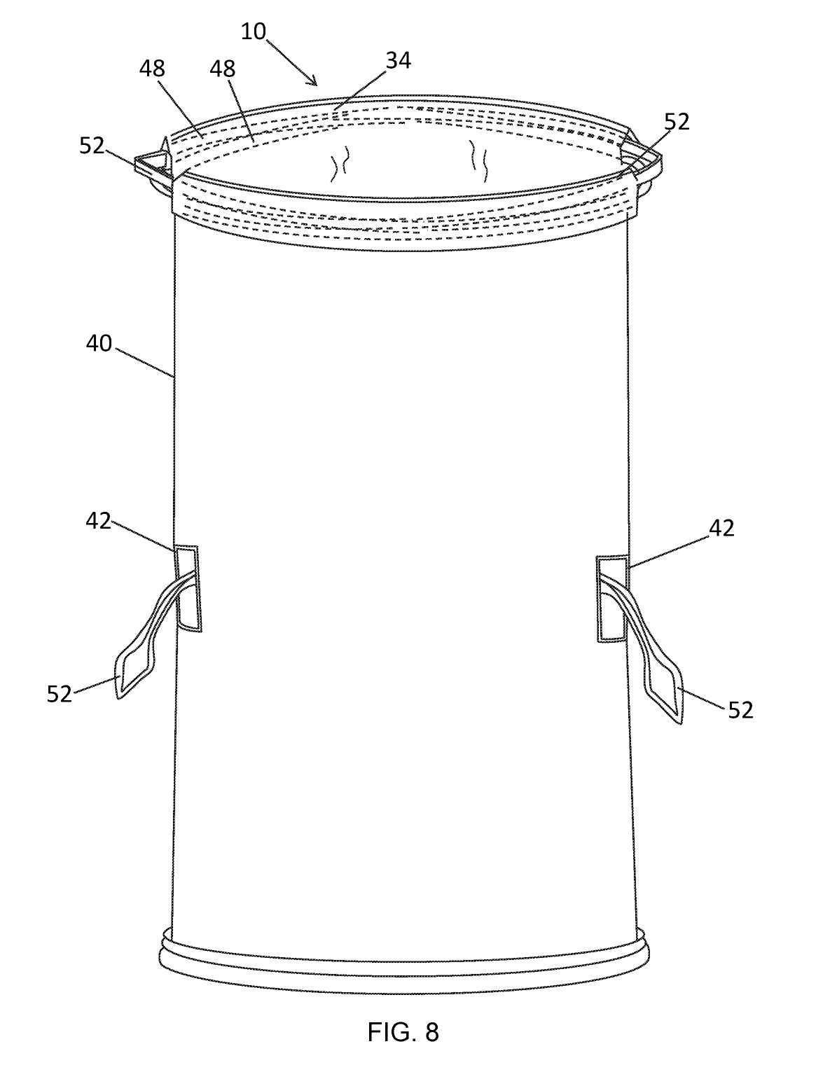

In a further embodiment of the partitioned liner bag 10, shown in an opened position in FIG. 5, the intermediate closure fixture 12 is formed with two straps 48 inserted through the sleeve 24. On each side of the partitioned liner bag 10 a slit 50 is formed through the sleeve 24, as shown in FIG. 6, and a handle 52 that is affixed to one side of each strap 48 extends from each of the slits 50. As shown in FIG. 7, the handles 52 may extend out from the cutouts 42 on either side of the waste receptacle 40 to be easily grasped and pulled out of the cutouts 42 as shown in FIG. 8 to seal the lower portion 14 of the partitioned liner bag 10.

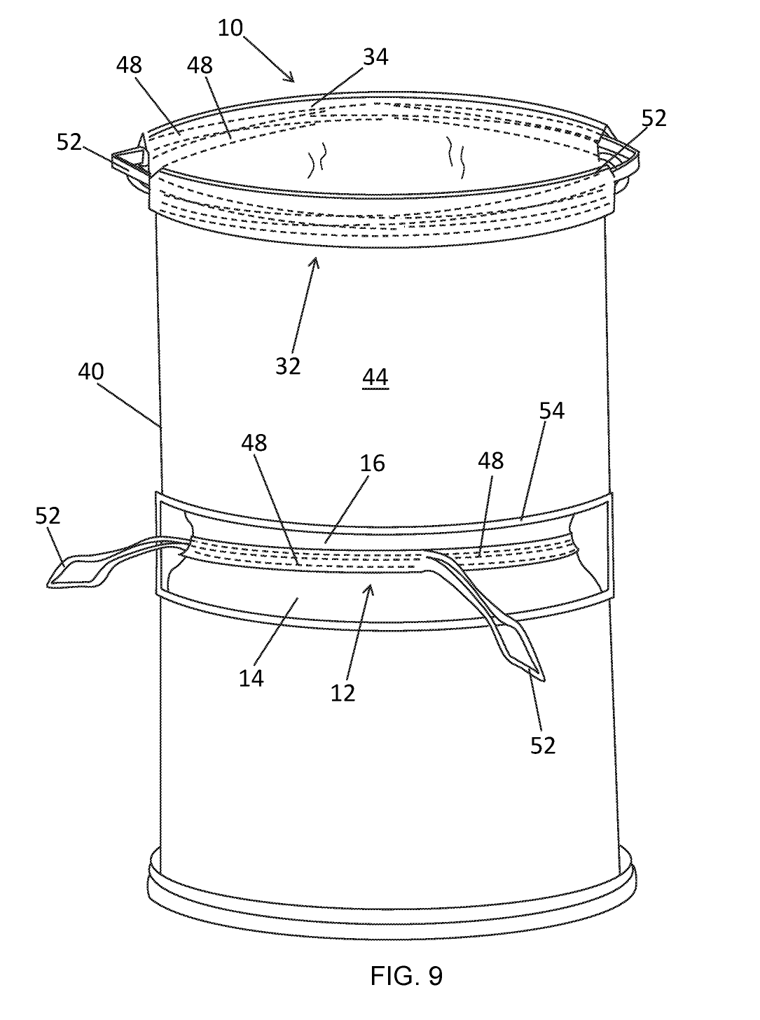

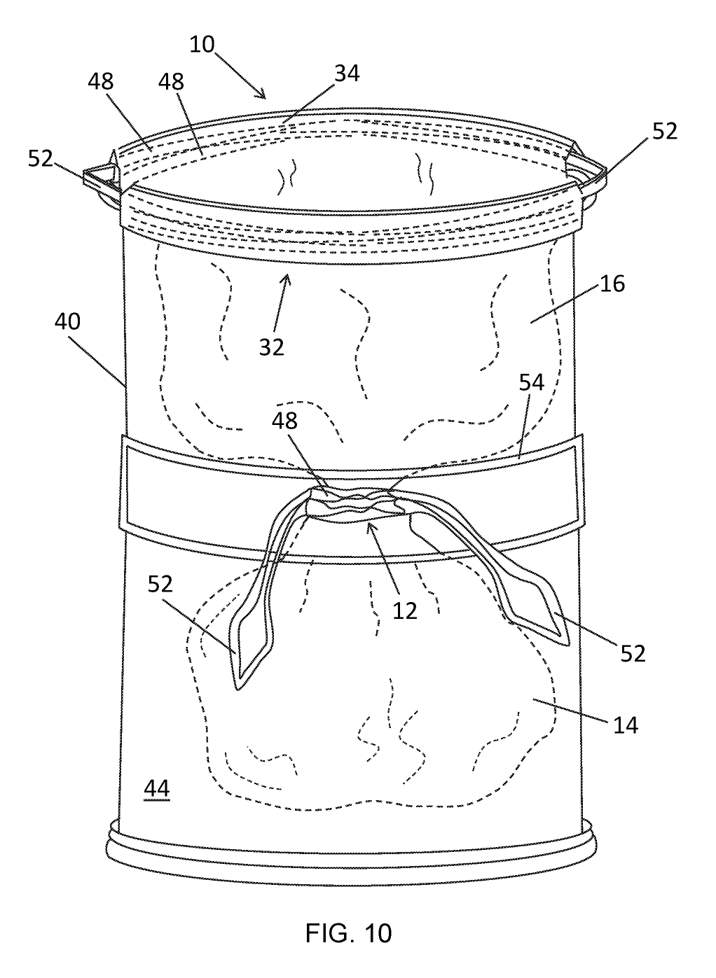

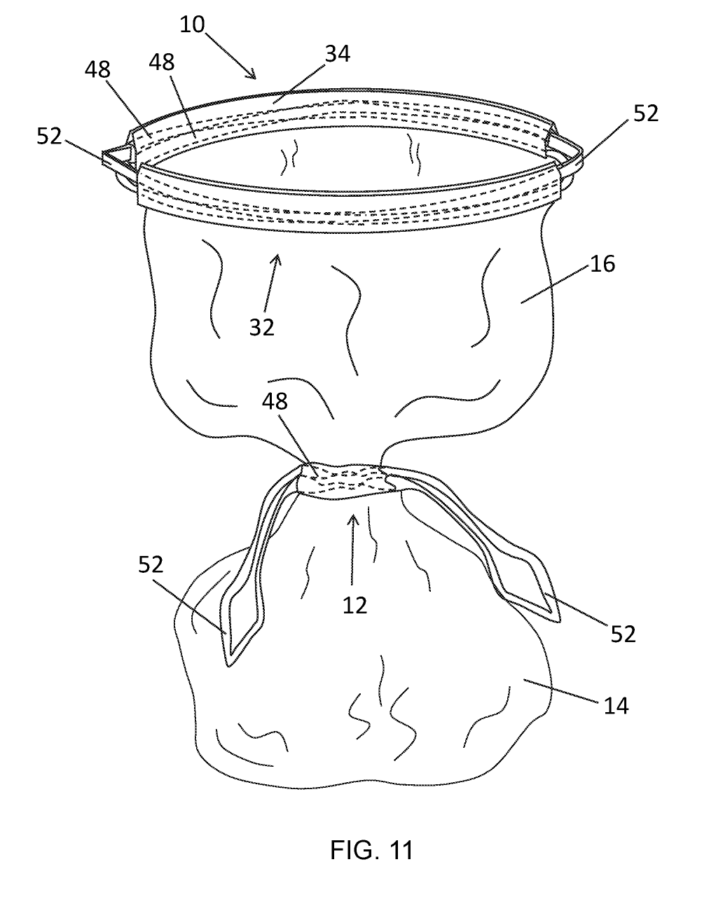

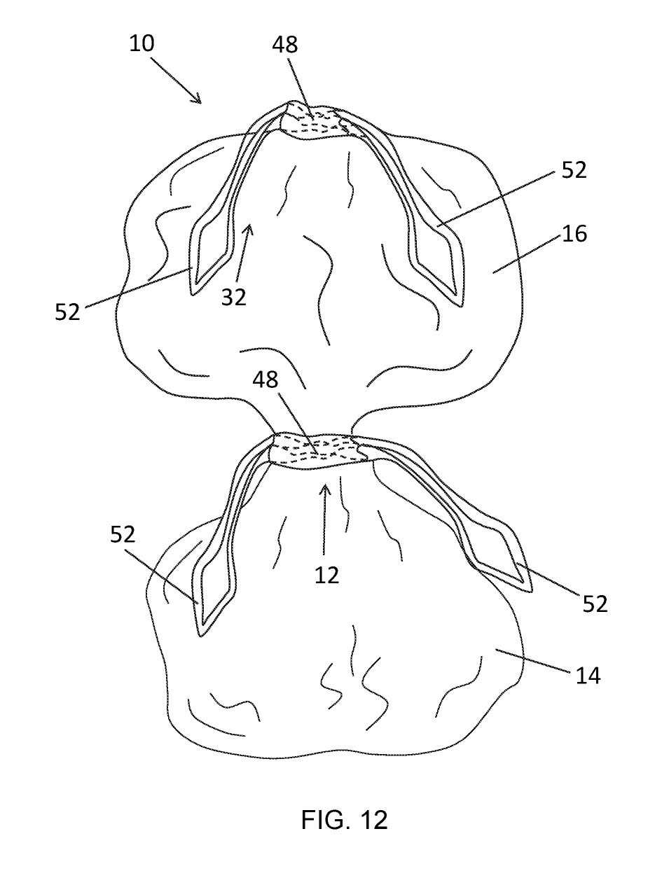

In a further embodiment of the waste receptacle 40, as shown in FIG. 9, a semicircular section 54 may be removed from the sidewall 44 to provide for greater access to the intermediate closure fixture 12 of the partitioned liner bag 10. As shown in FIG. 10, by reaching through the semicircular section 54, grasping the handles 52 and pulling, the lower portion 14 is easily closed without removal of the partitioned liner bag 10 from the waste receptacle 40. Once the lower portion 14 is closed, the upper portion 16 may be filled and then if desired the partitioned liner bag 10 may be removed from the waste receptacle 40, as shown in FIG. 11. The upper closure fixture 32 may be sealed by pulling the handles 52 or other type of closer fixture to seal the partitioned liner bag 10, as shown in FIG. 12.

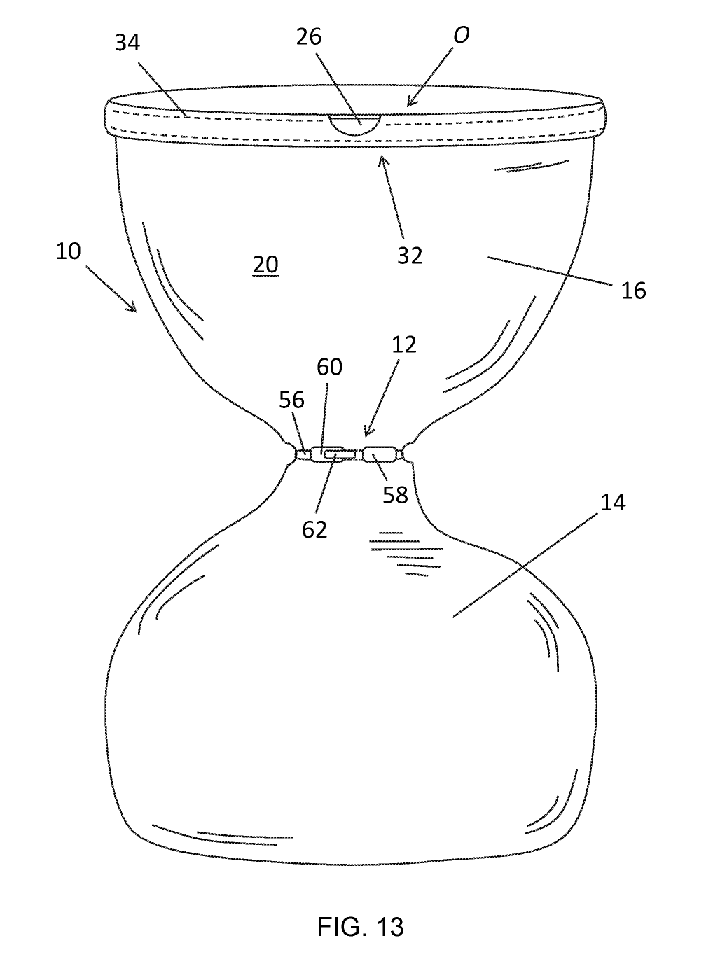

In embodiments of the partitioned liner bag 10, the intermediate closure fixture 12 and/or the upper closure fixture 32 may be of various types. As an example of some of the possible embodiments, an intermediate closure fixture 12 having a band 56 with adhesive pads on either end is shown in FIG. 13. In this embodiment, a first adhesive pad 58 is adhered to one side of the partitioned liner bag 10 and the band 56 extends through the sleeve 24 or extends along the outer surface 20 of the partitioned liner bag 10. A second adhesive pad 60 is removably adhered to a second side of the partitioned liner bag 10, so that when there is a desire to close the lower portion 14, a tab 62 is provided to pull the second adhesive pad 60 off of the outer surface 20 of the bag 10. The band 56 is then pulled around the partitioned liner bag 10 and the second adhesive pad 60 is re-adhered to the outer surface 20 of the partitioned liner bag 10 to seal the lower portion 14.

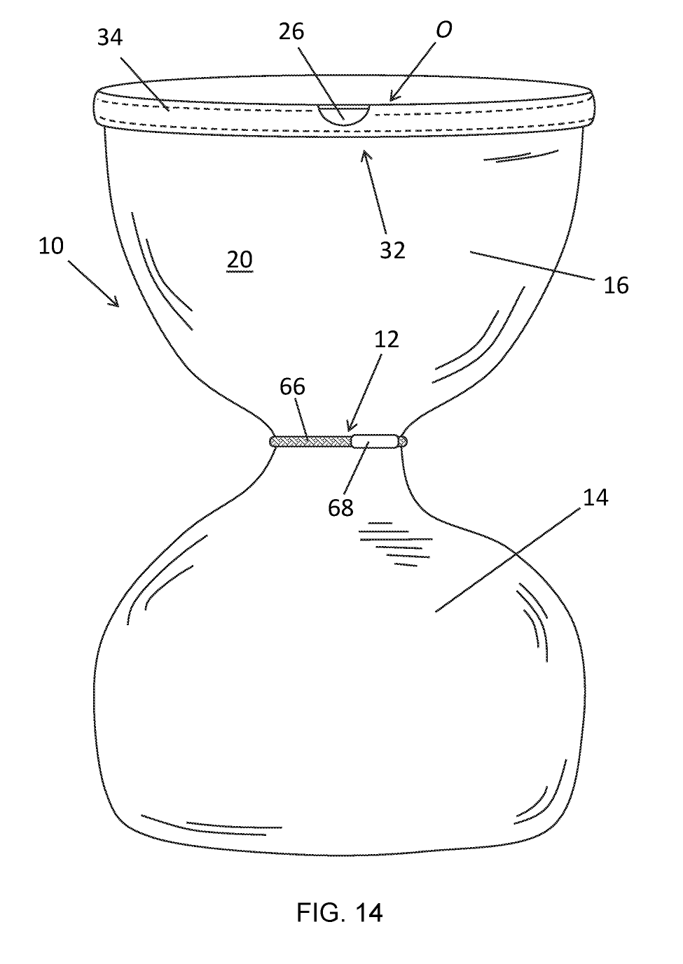

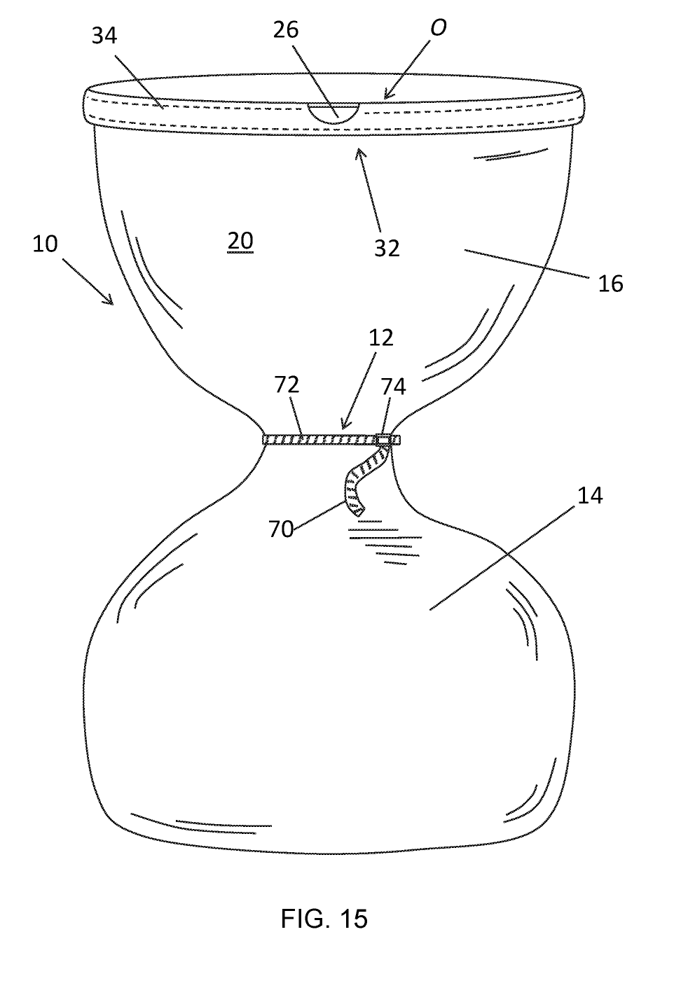

In another example as shown in FIG. 14, the intermediate closure fixture 12 and/or the upper closure fixture 32 may be a hook and loop fastener that is adhered along a portion of the outer surface 20 of the partitioned liner bag 10 exposing the hook and/or loop surface 66. At the end of the hook and loop fastener a fabric clip 68 providing the opposing hook and/or loop surface 66 is provided so that the lower portion 14 may be closed by pulling the fabric clip 68 and aligning it along the hook and/or loop surface 66 to seal the lower portion 14 of the partitioned liner bag 10. In a still further example as shown in FIG. 15, the intermediate closure fixture 12 is a cable tie 70 that is adhered to the outer surface 20 of the partitioned liner bag 10. The cable tie or tie wrap 70 has a serrated track 72 and a clip head 74. The clip head 74 provides a flexible tongue that allows the serrated track 72 to be pulled in through the clip head 74 in one direction but prevents the cable tie 70 from being pulled in the opposite direction and thereby secures and seals the lower portion 14 of the partitioned liner bag 10.

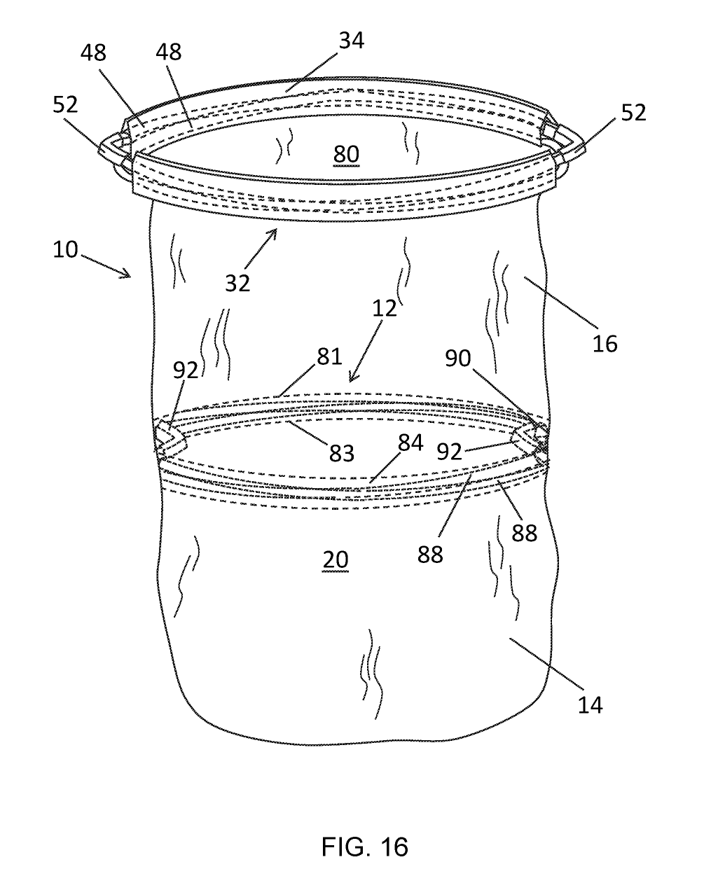

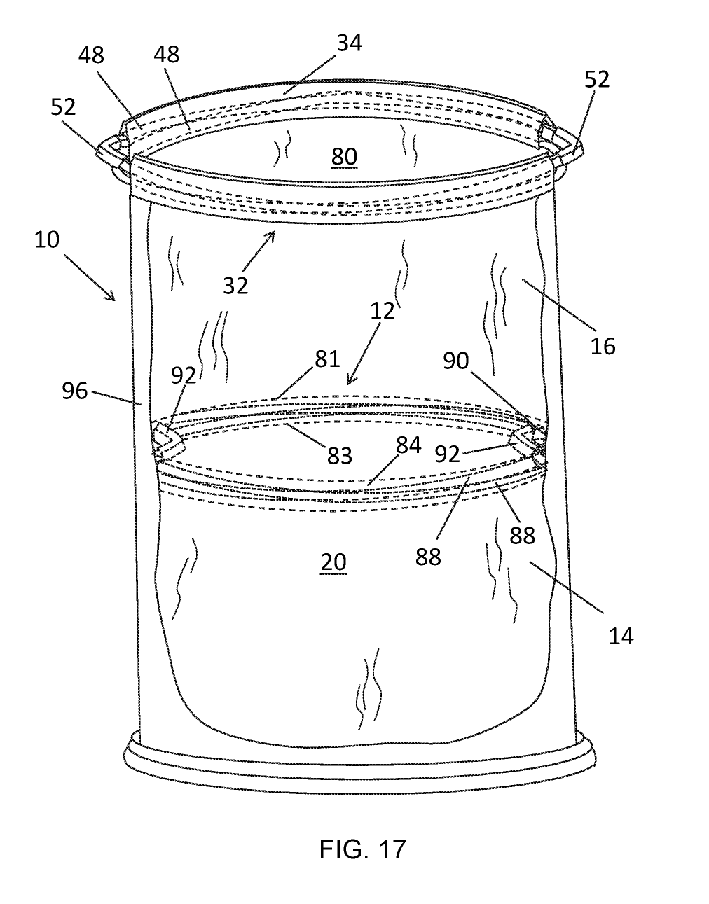

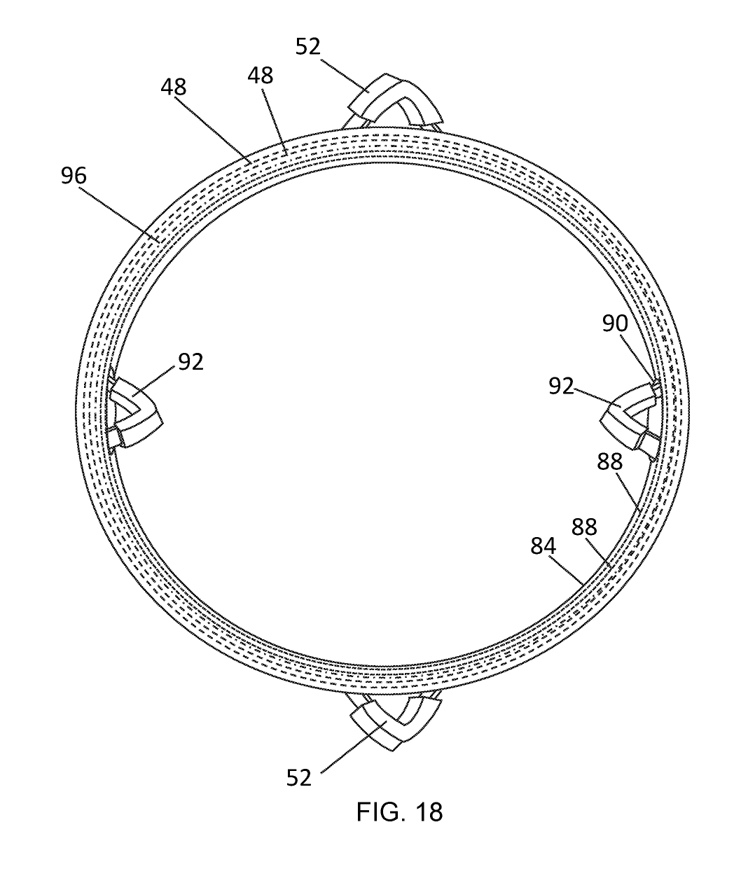

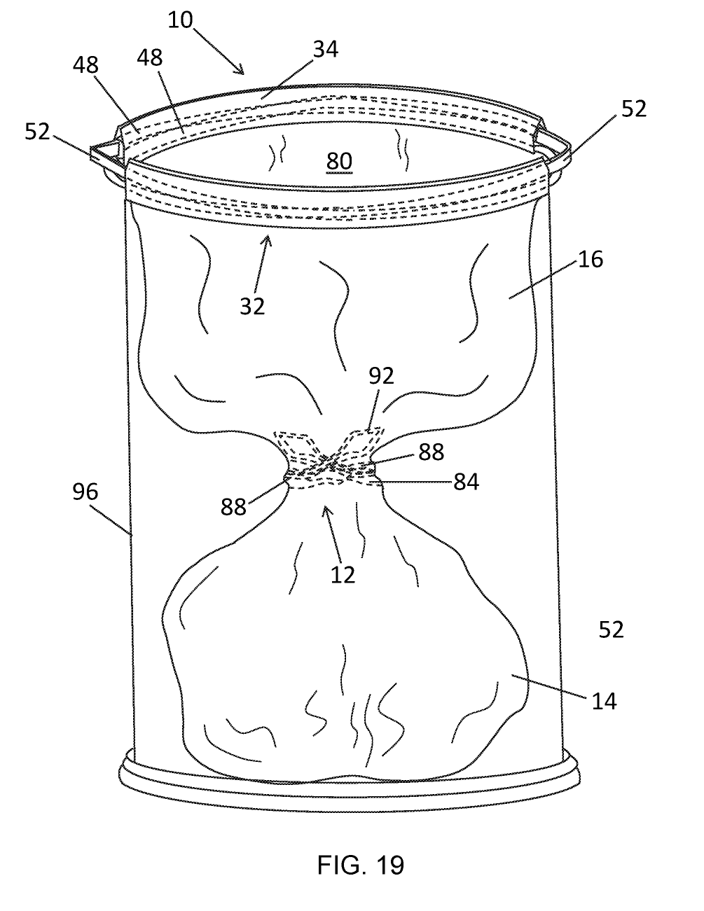

In a still further embodiment, the intermediate closure fixture 12 is placed along the interior surface 80 at an intermediate portion of the bag 10. In the embodiment shown in FIG. 16, some of the tubular sheet material is overlapped or additional sheet material is provided along the interior surface 80 to cover the intermediate closure fixture 12. The overlapped portion or sheet material is then adhered to the interior surface 80 of the plastic liner bag 10 along an upper edge 81 and a lower edge 83 to form a sleeve 84. The intermediate closure fixture 12 is inserted within the sleeve 84 along the interior surface 80 of the partitioned liner bag 10 and moves freely within the sleeve 84. In some embodiments of the partitioned liner bag 10, the intermediate closure fixture 12 is formed with two straps 88 inserted through the sleeve 84 and a slit 90 is formed through the sleeve 84 on each side of the partitioned liner bag 10. A handle 92 is affixed along the portion of each strap 88 that extends from each of the slits 90 formed through the sleeve 84. As shown in FIG. 16, the slits 90 extend only through the sleeve 84 and do not extend through the outer surface 20 of the partitioned liner bag 10. When placed in a waste receptacle 96, as shown in FIG. 17, the lower portion 14 of the partitioned liner bag 10 may be sealed from the upper portion 16 by pulling the handles 92 on either side of the partitioned liner bag 10 inwards and tying the handles 92 of the straps 88 together with the partitioned liner bag 10 still within the waste receptacle 96. The waste receptacle 96 may therefore be any type of basket or trash can without a requirement for cutouts to access the intermediate closure fixture 12 and seal the lower portion 14. As shown in a top view in FIG. 18, the handles 92 extend through the slits 90 and into the liner bag 10 to be easily grasped and pulled towards one another and be tied together to seal the lower portion 14 the partitioned liner bag 10. As shown in FIG. 19, the handles 92 when tied remain in the central part of the interior with the flexible sheet material drawn in to form a base to have additional rubbish be placed in the upper portion 16 to fill the liner bag 10. Odors from rubbish within the lower portion 14 are sealed and blocked using the intermediate closure fixture 12.

Other closer fixtures to seal the lower portion 14 and upper portion 16 that are along the outer surface or within the interior of the liner bag 10 are contemplated within the scope of the present invention.

As noted, the embodiments depicted herein are not intended to limit the scope of the present invention. Indeed, it is contemplated that any number of different embodiments may be utilized without diverging from the spirit of the invention. Therefore, the appended claims are intended to more fully encompass the scope of the present invention.

What is claimed is:

1. A plastic liner bag comprising:
a layered flexible sheet material sealed along a bottom portion and side edges to form a bag;
at least one closure fixture positioned along an intermediate portion of the bag; and
wherein the at least one intermediate closure fixture is configured to seal a portion of the bag.

2. The plastic liner bag of claim 1 wherein the intermediate closure fixture is accessible from the outside of the plastic liner bag.

3. The plastic liner bag of claim 1 wherein the intermediate closure fixture is accessible from the inside of the plastic liner bag.

4. The partitioned plastic liner bag of claim 1 wherein the intermediate closure fixture is a drawstring and wherein the drawstring is configured to seal a portion of the bag by pulling and tying off the drawstring.

5. The partitioned plastic liner bag of claim 1 wherein the intermediate closure fixture is a strap having a first handle and a second handle, the strap configured to seal a portion of the bag by pulling and tying the first and second handles together.

6. The plastic liner bag of claim 5 wherein the intermediate closure fixture is accessible from the inside of the plastic liner bag.

7. The partitioned plastic liner bag of claim 1 wherein the intermediate closure fixture is a band having a first loop and a second loop, the band configured to seal a portion of the bag by pulling the first loop through the second loop.

8. The plastic liner bag of claim 7 wherein the intermediate closure fixture is accessible from the inside of the plastic liner bag.

9. The partitioned plastic liner bag of claim 1 wherein the intermediate closure fixture is a draw tape having an adhesive tab, the draw tape configured to seal a portion of the bag by pulling and securing the adhesive tab to the bag or to the draw tape.

10. The partitioned plastic liner bag of claim 1 wherein the intermediate closure fixture is a hook and loop fastener configured to be aligned to seal a portion of the bag.

11. The partitioned plastic liner bag of claim 1 wherein the intermediate closure fixture is a tie wrap configured to seal a portion of the bag.

12. The partitioned plastic liner bag of claim 1 comprising a closure fixture positioned along an upper edge of the bag.

13. The partitioned plastic liner bag of claim 1 comprising a waste receptacle having cutouts to access the intermediate closure fixture and seal a portion of the bag without removing the bag from the waste receptacle.

14. The partitioned plastic liner bag of claim 1 comprising a waste receptacle having a semi-circular opening that extends through a portion of the sidewall of the waste receptacle to access the intermediate closure fixture to seal a portion of the bag without removing the bag from the waste receptacle.

15. A method of sealing a partitioned plastic liner bag to block odor in a waste receptacle, comprising:
layering a first flexible sheet material over a second flexible sheet material and sealing along a bottom portion and side edges to form a bag;
positioning at least one closure fixture in an intermediate portion along the bag; and
sealing a portion of the bag using the closure fixture positioned along an intermediate portion of the plastic liner bag.

16. The method of sealing a partitioned plastic liner bag to block odor in a waste receptacle of claim 15, comprising positioning the at least one intermediate closure fixture along an intermediate portion on the outside of the plastic liner bag.

17. The method of sealing a partitioned plastic liner bag to block odor in a waste receptacle of claim 15, comprising positioning the at least one intermediate closure fixture along an intermediate portion on the inside of the plastic liner bag.

18. The method of sealing a partitioned plastic liner bag to block odor in a waste receptacle of claim 15, comprising forming the intermediate closure fixture as a drawstring, the drawstring configured to be pulled and tied seal a portion of the plastic liner bag.

19. The method of sealing a partitioned plastic liner bag to block odor in a waste receptacle of claim 18, comprising positioning the at least one intermediate closure fixture along the inside of the plastic liner bag.

20. The method of sealing a partitioned plastic liner bag to block odor in a waste receptacle of claim 15, comprising forming the intermediate closure fixture as a strap with two handles, the strap configured to seal a portion of the plastic liner bag by tying the two handles together.

21. The method of sealing a partitioned plastic liner bag to block odor in a waste receptacle of claim 20, comprising positioning the at least one closure fixture along the inside of the plastic liner bag.

22. The method of sealing a partitioned plastic liner bag to block odor in a waste receptacle of claim 15, comprising forming the intermediate closure fixture as a draw tape having an adhesive tab, the draw tape configured to seal a portion of the plastic liner bag by pulling and securing the adhesive tab to the bag or to the draw tape.

23. The method of sealing a partitioned plastic liner bag to block odor in a waste receptacle of claim 15, comprising forming the intermediate closure fixture as a hook and loop fastener, the hook and loop fastener configured to be aligned to seal a portion of the plastic liner bag.

24. The method of sealing a partitioned plastic liner bag to block odor in a waste receptacle of claim 15, comprising forming the intermediate closure fixture as a tie wrap configured to seal a portion of the bag.

25. The method of sealing a partitioned plastic liner bag to block odor in a waste receptacle of claim 15, comprising forming a waste receptacle with at least one portion along its outer wall removed to form a cut out to provide access to the intermediate closure fixture without removing the bag from the waste receptacle.
